(19) United States
(12) Patent Application Publication
(10) Pub. No.: US 2024/0418938 A1
(43) Pub. Date: Dec. 19, 2024

(54) OPTICAL FILTER

(71) Applicant: Sumitomo Electric Industries, Ltd., Osaka (JP)

(72) Inventors: Takuo HIRATANI, Osaka-shi (JP); Takehiko KIKUCHI, Osaka-shi (JP); Tsutomu ISHIKAWA, Osaka-shi (JP); Naoki FUJIWARA, Osaka-shi (JP); Hideki YAGI, Osaka-shi (JP); Nobuhiko NISHIYAMA, Tokyo (JP)

(73) Assignee: Sumitomo Electric Industries, Ltd., Osaka (JP)

(21) Appl. No.: 18/662,144

(22) Filed: May 13, 2024

(30) Foreign Application Priority Data
Jun. 14, 2023 (JP) 2023-097835

(51) Int. Cl. G02B 6/293; G02B 6/30

(52) U.S. Cl. CPC G02B 6/29338; G02B 6/2932; G02B 6/30

(57) ABSTRACT

An optical filter includes a ring resonator, an optical waveguide configured to be optically coupled to the ring resonator, and a heater provided at the ring resonator. The ring resonator includes a first curved portion. The optical waveguide includes a second curved portion. The first curved portion and the second curved portion are configured to form a directional coupler. The heater is disposed above the directional coupler.

### CROSS REFERENCE TO RELATED APPLICATIONS

This application claims priority based on Japanese Patent Application No. 2023-097835 filed on Jun. 14, 2023, and the entire contents of the Japanese patent application are incorporated herein by reference.

### TECHNICAL FIELD

The present disclosure relates to an optical filter.

### BACKGROUND

A directional coupler is formed by bringing two optical waveguides close to each other (Non-patent literature 1: “Reduction of Wavelength Dependence of Coupling Characteristics Using Si Optical Waveguide Curved Directional Coupler” Hisayasu Morino, et al. Journal of Lightwave Technology, Vol. 32, No. 12, Jun. 15, 2014 p 2188-2192). Light travels from one optical waveguide to another optical waveguide. The ring-shaped optical waveguide forms a ring resonator. The ring resonator and the optical waveguide form the directional coupler, and thus light is transferred. The wavelength of light can be changed by changing the temperature of a ring resonator with a heater (Non-Patent Literature 2: “A 2.5 kHz Linewidth Widely Tunable Laser with Booster SOA Integrated on Silicon” Minh A. et al. 2018 IEEE International Semiconductor Laser Conference (ISLC)).

### SUMMARY

An optical filter according to the present disclosure includes a ring resonator; an optical waveguide configured to be optically coupled to the ring resonator; and a heater provided at the ring resonator. The ring resonator includes a first curved portion. The optical waveguide includes a second curved portion. The first curved portion and the second curved portion are configured to form a directional coupler. The heater is disposed above the directional coupler.

### BRIEF DESCRIPTION OF THE DRAWINGS

FIG. 1 is a plan view illustrating an optical filter according to an embodiment.

FIG. 2A is an enlarged view of a directional coupler.

FIG. 2B is a diagram illustrating the relationship between angle and radius of curvature.

FIG. 3A is a cross-sectional view taken along line A-A of FIG. 1.

FIG. 3B is a cross-sectional view taken along line B-B of FIG. 1.

FIG. 4 is a diagram illustrating a spectrum of light.

FIG. 5 is a plan view illustrating an optical filter according to a comparative example.

FIG. 6 is a schematic diagram illustrating a coupling coefficient of the directional coupler.

### DETAILED DESCRIPTION

The coupling coefficient of a directional coupler varies depending on temperature. Due to the change in the coupling coefficient, intended characteristics may not be obtained. Thus, it is an object of the present disclosure to provide an optical filter capable of suppressing the temperature dependence of the coupling coefficient.

### Description of Embodiments of Present Disclosure

First, the contents of embodiments of the present disclosure will be listed and explained.
(1) An optical filter according to an embodiment of the present disclosure includes a ring resonator; an optical waveguide configured to be optically coupled to the ring resonator; and a heater provided at the ring resonator. The ring resonator includes a first curved portion. The optical waveguide includes a second curved portion. The first curved portion and the second curved portion are configured to form a directional coupler. The heater is disposed above the directional coupler. The wavelength of light is changed by changing the temperature of the ring resonator using the heater. The first curved portion and the second curved portion form the directional coupler. Thus, the temperature dependence of the coupling coefficient is suppressed. The wavelength of light can be changed, and the change in the coupling coefficient can be suppressed.
(2) In (1), the heater may be provided at a portion of the ring resonator, the portion forming the directional coupler, and at a portion of the ring resonator except for the directional coupler. The portion of the ring resonator, covered by the heater, is longer. The portion to which heat is transmitted from the heater becomes large. The temperature of the ring resonator is likely to change. An increase in power consumption can be suppressed.
(3) In (1) or (2), the heater may be provided above a portion of the ring resonator, the portion being 70% or more of the ring resonator. The portion of the ring resonator, covered by the heater, is longer. The portion to which heat is transmitted from the heater becomes large. The temperature of the ring resonator is likely to change. An increase in power consumption can be reduced.
(4) In any one of (1) to (3), the first curved portion and the second curved portion may be each curved toward outside the ring resonator. The first curved portion and the second curved portion form the directional coupler. Light can travel between the ring resonator and the optical waveguide.
5) In any one of (1) to (4), a radius of curvature of the first curved portion and a radius of curvature of the second curved portion may be each 5 μm to 350 μm. The temperature dependency of the coupling coefficient is reduced.
(6) In any one of (1) to (5), a distance between the ring resonator and the optical waveguide may be shortest in the directional coupler. Light is transferred easily in the directional coupler, and is not transferred easily in the portion except for the directional coupler. The wavelength and intensity of the light can be of any desired magnitude.
(7) In any one of (1) to (6), the optical filter may include a silicon layer. The silicon layer may include waveguide cores. One of the waveguide cores may be the ring resonator. Another one of the waveguide cores may be the optical waveguide. The one of the waveguide cores and the another one of the waveguide cores may be adjacent to each other in the directional coupler. Light is transferred between waveguide cores. The ring resonator and the optical waveguide are formed of silicon. Light can be strongly confined in the ring resonator and the optical waveguide, and the loss of light can be reduced.
(8) In any one of (1) to (7), The optical filter may include two optical waveguides each of which is the optical waveguide. Each of the two optical waveguides may include the second curved portion. The second curved portions may be each configured to form the directional coupler together with the first curved portion. Light travels from one optical waveguide to the ring resonator. Light travels from the ring resonator to another optical waveguide. Light having the resonance wavelength of the ring resonator can be extracted.
(9) In (8), in a direction around the ring resonator, a length of the ring resonator from one of two directional couplers each of which is the directional coupler to another one of the two directional couplers may be equal to a length of the ring resonator from the another one of the two directional couplers to the one of the two directional couplers. Optical path lengths between the two directional couplers are close to the same. The phase of light is less likely to shift.

### Details of Embodiments of Present Disclosure

Specific examples of an optical filter according to embodiments of the present disclosure will be described below with reference to the drawings. The present disclosure is not limited to these examples, but is defined by the scope of the claims, and is intended to include all modifications within the meaning and scope equivalent to the scope of the claims.

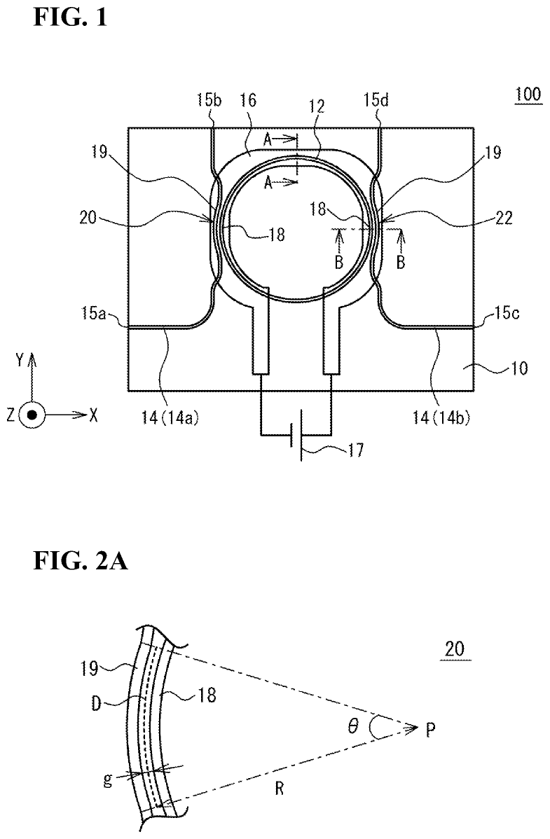

FIG. 1 is a plan view illustrating an optical filter 100 according to the embodiment. Optical filter 100 includes a substrate 10, a ring resonator 12, an optical waveguide 14, and a heater 16. Optical filter 100 is an optical filter of a waveguide type.

The planar shape of substrate 10 is, for example, a rectangle. The two sides of substrate 10 are parallel to the X-axis direction. The other two sides are parallel to the Y-axis direction. The upper surface of substrate 10 is parallel to the XY plane. The Z-axis direction is a normal direction of substrate 10. The X-axis direction, the Y-axis direction, and the Z-axis direction are orthogonal to each other.

Substrate 10 is a silicon on insulator (SOI) substrate and includes a box layer. Ring resonator 12 and optical waveguide 14 are embedded in the box layer. In FIG. 1, the box layer is seen through. Heater 16 is provided on the upper surface of substrate 10 and is positioned above ring resonator 12. A power supply 17 is electrically connected to heater 16.

Ring resonator 12 is positioned between two optical waveguides 14. Ring resonator 12 is formed of a ring-shaped optical waveguide. The ring is a circle, an ellipse, a polygon, a shape obtained by combining an arc and a straight line, or the like. Ring resonator 12 has a diameter of, for example, 150 μm. Ring resonator 12 has two curved portions 18. Two curved portions 18 are opposed to each other. Curved portion 18 is curved toward outside ring resonator 12. Ring resonator 12 is line-symmetric with respect to the Y axis and also line-symmetric with respect to the X axis.

The planar shape of optical waveguide 14 is, for example, an L-shape. One of two optical waveguides 14 is referred to as an optical waveguide 14a (first optical waveguide), and the other is referred to as an optical waveguide 14b (second optical waveguide). Optical waveguide 14a and optical waveguide 14b are spaced apart from each other. An end portion 15a of optical waveguide 14a is positioned at one end portion of substrate 10 (the first end portion of substrate 10) in the X-axis direction. An end portion 15c of optical waveguide 14b is positioned at the other end portion of substrate 10 (the second end portion of substrate 10) in the X-axis direction. An end portion 15b of optical waveguide 14a and an end portion 15d of optical waveguide 14b are positioned at one end portion of substrate 10 in the Y-axis direction. Optical waveguide 14a and optical waveguide 14b each have a curved portion 19. Curved portion 19 is curved toward outside ring resonator 12. Curved portion 19 of optical waveguide 14a and curved portion 19 of optical waveguide 14b are line-symmetric with respect to the Y axis.

One curved portion 18 (first curved portion) of ring resonator 12 and curved portion 19 (second curved portion) of optical waveguide 14a face each other to form a directional coupler 20 (first directional coupler). In directional coupler 20, ring resonator 12 and optical waveguide 14a are optically coupled. Ring resonator 12 and optical waveguide 14a are spaced apart from each other. In directional coupler 20, the distance between ring resonator 12 and optical waveguide 14a is shortest, for example, 200 nm.

The other curved portion 18 (first curved portion) of ring resonator 12 and curved portion 19 (second curved portion) of optical waveguide 14b face each other to form a directional coupler 22 (second directional coupler). In directional coupler 22, ring resonator 12 and optical waveguide 14b are optically coupled. Ring resonator 12 and optical waveguide 14b are spaced apart from each other. In directional coupler 22, the distance between ring resonator 12 and optical waveguide 14b is shortest, for example, 200 nm.

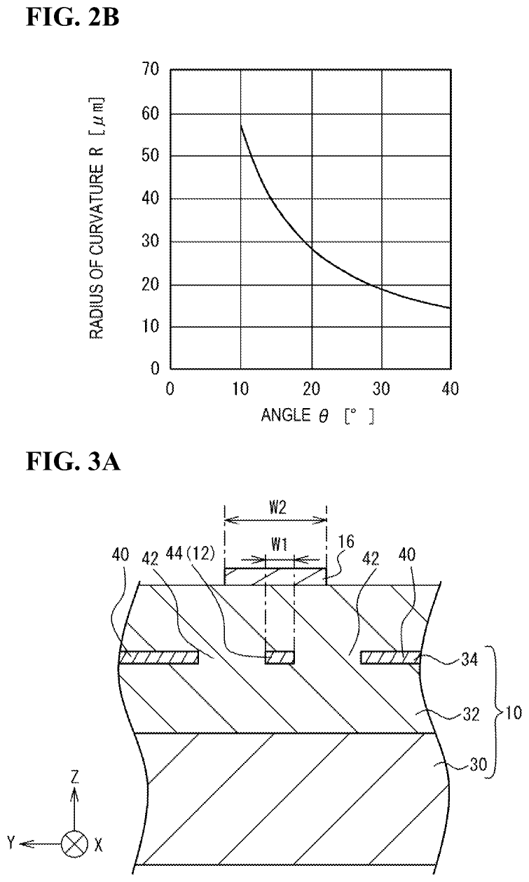

FIG. 2A is an enlarged view of directional coupler 20. In directional coupler 20, curved portion 18 of ring resonator 12 and curved portion 19 of optical waveguide 14a extend in the same direction. A distance g between ring resonator 12 and optical waveguide 14a is, for example, 200 nm. A dotted line D in FIG. 2A is an arc and represents a position midway between curved portion 18 and curved portion 19. P is the center of the dotted line D. The radius of curvature of the dotted line D is represented by R. R is greater than the radius of curvature of curved portion 18 and less than the radius of curvature of curved portion 19. The central angle of directional coupler 20 is represented by θ. Directional coupler 20 has the same configuration as directional coupler 22.

FIG. 2B is a diagram illustrating the relationship between the angle θ and the radius of curvature R. The horizontal axis represents an angle. The vertical axis represents the radius of curvature R. The smaller the angle θ, the larger the radius of curvature R. The larger the angle θ, the smaller the radius of curvature R. The radius of curvature R is, for example, 5 m to 350 μm. The angle θ is, for example, 10° to 60°.

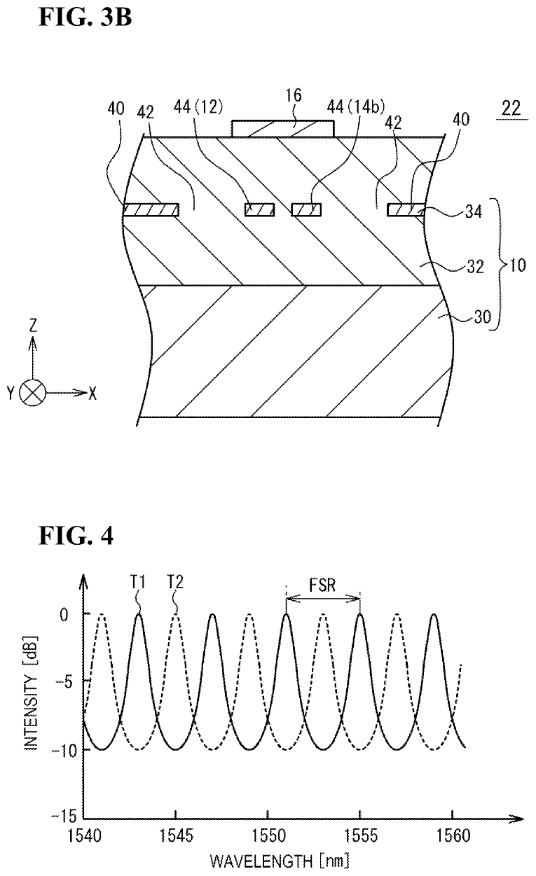

FIG. 3A is a cross-sectional view taken along line A-A of FIG. 1. FIG. 3B is a cross-sectional view taken along line B-B of FIG. 1. As shown in FIGS. 3A and 3B, substrate 10 includes a substrate 30, a box layer 32, and a silicon (Si) layer 34. Box layer 32 is laminated on one surface of substrate 30. Si layer 34 is embedded in box layer 32.

Si layer 34 has a terrace 40 and a waveguide core 44. Terrace 40 is planar. A recessed portion 42 is provided between terrace 40 and waveguide core 44. As shown in FIGS. 3A and 3B, recessed portion 42 may go through Si layer 34. Recessed portion 42 does not have to go through Si layer 34. Waveguide core 44 functions as an optical waveguide. Box layer 32 is filled on the lower surface and the upper surface of terrace 40, on the lower surface and the upper surface of waveguide core 44, and between terrace 40 and waveguide core 44.

Substrate 30 is formed of, for example, Si. Box layer 32 is formed of, for example, silicon oxide (SiO₂). The thickness of Si layer 34 is, for example, 0.22 μm. A width W1 of waveguide core 44 is, for example, 0.42 μm. The refractive index of box layer 32 is about 1.4. The refractive index of Si layer 34 is about 3.5, which is higher than that of box layer 32.

Waveguide core 44 of FIG. 3A functions as ring resonator 12. First terrace 40, waveguide core 44, and second terrace 40 are arranged in this order. Heater 16 is provided on the upper surface of box layer 32 and is positioned above waveguide core 44. Heater 16 is formed of metal such as platinum (Pt). A width W2 of heater 16 is, for example, 3 μm. The thickness of heater 16 is, for example, 200 nm.

In FIG. 3B, two waveguide cores 44 are arranged. One waveguide core 44 (first waveguide core) is ring resonator 12. The other waveguide core 44 (second waveguide core) is optical waveguide 14. Box layer 32 is provided between two waveguide cores 44, and terrace 40 is not provided between them. First terrace 40, one waveguide core 44, the other waveguide core 44, and second terrace 40 are arranged in this order. Heater 16 is positioned above two waveguide cores 44.

For example, end portion 15a of optical waveguide 14a functions as an input port. End portion 15c of optical waveguide 14b functions as an output port. Light is incident on end portion 15a from a light source. The light propagates through optical waveguide 14a. In directional coupler 20, the light travels from optical waveguide 14a to ring resonator 12. The light propagates through ring resonator 12. The light of a resonance wavelength of ring resonator 12 travels from ring resonator 12 to optical waveguide 14b in directional coupler 22. The light having the resonance wavelength propagates through optical waveguide 14b and is emitted from end portion 15c. The light having the resonance wavelength can be extracted from optical filter 100. The light having a wavelength different from the resonance wavelength propagates through optical waveguide 14a and is emitted from end portion 15b.

A voltage may be applied to heater 16 using power supply 17 to cause a current to flow through heater 16. When the current flows, heater 16 generates heat. The temperature of ring resonator 12 changes due to the heat being transmitted from heater 16 to ring resonator 12. The refractive index of ring resonator 12 changes due to the change in temperature. The resonance wavelength of ring resonator 12 changes due to the change in the refractive index.

FIG. 4 is a diagram illustrating a spectrum of light. The horizontal axis represents the wavelength of light. The vertical axis represents the intensity of light. The solid line in FIG. 4 is an example in which the temperature of ring resonator 12 is T1. The dotted line is an example in which the temperature is T2. T2 is, for example, 25° C. higher than T1. The intensity of light exhibits a peak at the resonance wavelength. The interval (FSR) between two adjacent peaks is several nm. By changing the temperature, the wavelength of the peak shifts. When the wavelengths are shifted by the FSR, the power consumption of heater 16 is, for example, 50 mW.

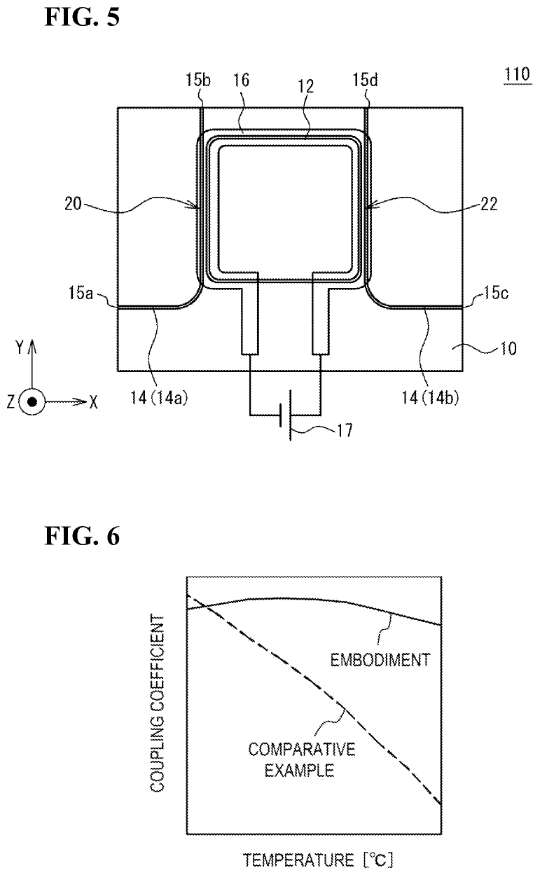

FIG. 5 is a plan view illustrating an optical filter 110 according to a comparative example. Ring resonator 12 has a rectangular shape. Optical waveguide 14a or optical waveguide 14b do not have curved portion 19. The linear portion of ring resonator 12 and optical waveguide 14a form directional coupler 20. In directional coupler 20, ring resonator 12 and optical waveguide 14a are parallel to each other. The linear portion of ring resonator 12 and optical waveguide 14b form directional coupler 22. In directional coupler 22, ring resonator 12 and optical waveguide 14b are parallel to each other.

FIG. 6 is a schematic view illustrating a coupling coefficient of the directional coupler. The horizontal axis represents the temperature of ring resonator 12. The left side of the horizontal axis is low temperature, and the right side is high temperature. The vertical axis represents the coupling coefficient. The dashed line in FIG. 6 represents the comparative example. The solid line represents the embodiment. The coupling coefficient of the comparative example decreases as the temperature increases. A Q value deviates from the value at the time of design. The shape of the spectrum changes in response to the change in temperature.

On the other hand, the change in the coupling coefficient of the embodiment is suppressed. For example, the designed value of the coupling coefficient is set to 50%. In the comparative example, the coupling coefficient decreases to 40% due to the change in temperature of from several tens of degrees to around 200° C. The coupling coefficient of the embodiment is maintained in a range of 50%±1%.

According to the embodiment, curved portion 18 of ring resonator 12 and curved portion 19 of optical waveguide 14a form directional coupler 20. Curved portion 18 and curved portion 19 of optical waveguide 14b form directional coupler 22. Light is transferred between optical waveguide 14 and ring resonator 12. The light having the resonance wavelength of ring resonator 12 can be extracted. As shown in FIG. 4, the resonance wavelength is changed by changing the temperature of ring resonator 12 by heater 16. As shown in FIG. 6, the coupling coefficient of the directional coupler formed by the curved optical waveguides is less likely to change with temperature than the coupling coefficient of the directional coupler formed by the linear optical waveguides. That is, the temperature dependence of the coupling coefficient is small. By changing the temperature, the resonance wavelength can be changed and the change in the coupling coefficient can be suppressed.

Since the temperature dependency of the coupling coefficient is small, the Q value is close to the designed value even when the temperature is changed. The change in the shape of the spectrum is suppressed. The wavelength of the peak changes while the height, the line width, and the like of the spectrum are maintained at desired values.

In the comparative example shown in FIG. 5, heater 16 is not provided on directional coupler 20 or directional coupler 22, and thus the change in the coupling coefficient is suppressed. However, the portion of ring resonator 12, covered by heater 16, is shortened. Since the portion to which heat is transmitted from heater 16 is reduced, the temperature is hardly changed. To change the temperature, the power input to heater 16 is increased. The power consumption increases. The generated heat increases, and heater 16 or the like may be damaged.

According to the embodiment, heater 16 is provided above ring resonator 12, and covers a portion of ring resonator 12, the portion forming the directional coupler, and a portion except for the directional coupler. For example, heater 16 covers two curved portions 18 of ring resonator 12, and covers the upper half of ring resonator 12 in FIG. 1 and a part of the lower half of ring resonator 12. The portion of ring resonator 12, covered by heater 16, is longer. The portion to which heat is transmitted from heater 16 is increased. Thus, the temperature of ring resonator 12 is likely to change, and an increase in power consumption can be reduced. The damage to heater 16 and the like due to heat is reduced.

The longer the portion of ring resonator 12, covered by heater 16, the larger the portion to which heat is transmitted from heater 16. The ratio of the length of the portion covered by heater 16 to the length (circumferential length) of ring resonator 12 may be 50% or more, 60% or more, 70% or more, 80% or more, or 90% or more.

As shown in FIG. 2A, curved portion 18 of ring resonator 12 and curved portion 19 of optical waveguide 14 are curved in the same direction. Curved portion 18 and curved portion 19 are curved toward outside ring resonator 12. Curved portion 18 and curved portion 19 form each of directional couplers 20 and 22. Light can be transferred between ring resonator 12 and optical waveguide 14. The target value of the coupling coefficient of the directional coupler may be 50%, may be 50% or less, or may be 50% or more. The distances g, width W1, the length of the directional couplers, and the like are adjusted according to the target values of the coupling coefficients.

Each of curved portion 18 and curved portion 19 may be an arc, an elliptical arc, or the like. Each of curved portion 18 and curved portion 19 may have a shape that is convex toward outside ring resonator 12 or a shape that is convex toward inside ring resonator 12.

Each radius of curvature of curved portion 18 and curved portion 19 is, for example, 5 μm to 350 μm. When the radius of curvature is large, the shapes of curved portion 18 and curved portion 19 are close to a straight line. The temperature dependency of the coupling coefficient increases. When the radius of curvature is small, the shapes of curved portion 18 and curved portion 19 are curved rather than straight. The temperature dependency of the coupling coefficient is reduced. The radius of curvature is set to an appropriate size depending on the material of the waveguide and the like.

In the directional coupler, the distance between ring resonator 12 and optical waveguide 14 is shortest. The minimum value of the distance g is, for example, 200 nm. In the portion except for the directional coupler, the distance between ring resonator 12 and optical waveguide 14 becomes larger. Optical waveguide 14a is curved along curved portion 18 of ring resonator 12 in directional coupler 20. Optical waveguide 14a is curved so as to be away from ring resonator 12 when optical waveguide 14a is away from directional coupler 20. Optical waveguide 14b has a similar shape. Light is transferred easily in the directional coupler, and is not transferred easily in the portion except for the directional coupler. The wavelength and intensity of the light can be of any desired magnitude.

Substrate 10 is an SOI substrate and has Si layer 34. Si layer 34 has waveguide core 44. The ring-shaped waveguide core 44 serves as ring resonator 12. Another waveguide core 44 becomes optical waveguide 14. As shown in FIG. 3B, two waveguide cores 44 are adjacent to each other, thereby forming the directional coupler. Light travels between waveguide cores 44. Ring resonator 12 and optical waveguide 14 are formed of Si. The refractive index of Si layer 34 is higher than that of box layer 32. Light is strongly confined in ring resonator 12 and optical waveguide 14, and the loss of light can be reduced.

Optical filter 100 includes two optical waveguides 14. Curved portions 19 of two optical waveguides 14 form directional couplers with curved portions 18 of ring resonator 12. Light travels from one optical waveguide 14a to ring resonator 12. The light travels from ring resonator 12 to the other optical waveguide 14b. The light having the resonance wavelength of ring resonator 12 can be extracted. The number of optical waveguides 14 may be one, or three or more. Each of optical waveguides 14 has curved portion 19, which forms directional coupler with each curved portion 18 of ring resonator 12.

Directional coupler 20 and directional coupler 22 face each other in the X-axis direction. Ring resonator 12 is line-symmetric with respect to the X-axis. In a rotation direction around ring resonator 12 (for example, in a clockwise direction), the length of ring resonator 12 from directional coupler 20 to directional coupler 22 is equal to the length from directional coupler 22 to directional coupler 20. That is, the two directional couplers divide ring resonator 12 into two equal parts. The optical path lengths between directional coupler 20 and directional coupler 22 are close to the same. The phase of light is less likely to shift. The intensity of light is less likely to decrease. Directional coupler 20 and directional coupler 22 may be line-symmetric with respect to the Y axis. The phase of light is less likely to shift. The length of ring resonator 12 from directional coupler 20 to directional coupler 22 does not have to be exactly equal to the length from directional coupler 22 to directional coupler 20. The difference of the lengths may be, for example, 5% or less, or 1% or less.

Although the embodiments of the present disclosure have been described in detail, the present disclosure is not limited to the specific embodiments, and various modifications and changes can be made within the scope of the gist of the present disclosure described in the claims.

What is claimed is:

1. An optical filter comprising:
a ring resonator;
an optical waveguide configured to be optically coupled to the ring resonator; and
a heater provided at the ring resonator,
wherein the ring resonator includes a first curved portion,
wherein the optical waveguide includes a second curved portion,
wherein the first curved portion and the second curved portion are configured to form a directional coupler, and
wherein the heater is disposed above the directional coupler.

2. The optical filter according to claim 1,
wherein the heater is provided at a portion of the ring resonator, the portion forming the directional coupler, and at a portion of the ring resonator except for the directional coupler.

3. The optical filter according to claim 1,
wherein the heater is provided above a portion of the ring resonator, the portion being 70% or more of the ring resonator.

4. The optical filter according to claim 1,
wherein the first curved portion and the second curved portion are each curved toward outside the ring resonator.

5. The optical filter according to claim 1,
wherein a radius of curvature of the first curved portion and a radius of curvature of the second curved portion are each 5 μm to 350 μm.

6. The optical filter according to claim 1,
wherein a distance between the ring resonator and the optical waveguide is shortest in the directional coupler.

7. The optical filter according to claim 1, comprising:
a silicon layer,
wherein the silicon layer includes waveguide cores,
wherein one of the waveguide cores is the ring resonator,
wherein another one of the waveguide cores is the optical waveguide, and
wherein the one of the waveguide cores and the another one of the waveguide cores are adjacent to each other in the directional coupler.

8. The optical filter according to claim 1, comprising:
two optical waveguides each of which is the optical waveguide,
wherein each of the two optical waveguides includes the second curved portion, and
wherein the second curved portions are each configured to form the directional coupler together with the first curved portion.

9. The optical filter according to claim 8,
wherein, in a direction around the ring resonator, a length of the ring resonator from one of two directional couplers each of which is the directional coupler to another one of the two directional couplers is equal to a length of the ring resonator from the another one of the two directional couplers to the one of the two directional couplers.
